(19) United States
(12) Patent Application Publication
(10) Pub. No.: US 2025/0334752 A1
(43) Pub. Date: Oct. 30, 2025

(54) FIBER OPTIC CONNECTION DEVICE

(71) Applicant: Xue-feng Chen, Guangzhou City (CN)

(72) Inventor: Xue-feng Chen, Guangzhou City (CN)

(21) Appl. No.: 18/648,489

(22) Filed: Apr. 29, 2024

(51) Int. Cl. G02B 6/38

(52) U.S. Cl. CPC G02B 6/3882; G02B 6/3825

(57) ABSTRACT

A fiber optic connection device includes a first fiber optic connector which has a first housing and a first fiber fixing member assembled within the first housing. One side surface of the first fiber fixing member has a first contact surface which is a first inclined plane. A second fiber optic connector includes a second housing and a second fiber fixing member assembled within the second housing. One side of the second fiber fixing member has a second contact surface which is a second inclined plane. The second inclined plane is located corresponding to the first inclined plane of the first contact surface. A fiber optic adapter having two ends thereof respectively accommodating the first fiber optic connector and the second fiber optic connector. The first contact surface of the first fiber fixing member forms a connection with the second contact surface of the second fiber fixing member.

### FIELD OF THE INVENTION

The present invention relates to the field of multi-core fiber optic communication connection technology, and more particularly, to a fiber optic connection device.

### BACKGROUND OF THE INVENTION

In today's era of exploding demand for information, to meet the needs of data capacity, transmission speed, and low loss, fiber optic transmission has replaced copper wire transmission as the mainstream for high-speed transmission. Fiber optic connectors are mostly used as the standard cable connection medium for data transmission for the fixation and tension resistance of optical fibers. However, fiber optic transmission requires high precision in positioning and tight contact between transmission surfaces. It is easily affected by external forces to a certain extent or frequent plugging and unplugging, which may compromise the tightness of fiber optic connections and result in low efficiency of fiber optic transmission, rendering it unable to function properly. Therefore, providing a fiber optic connector with stable fiber optic transmission is currently an urgent technological problem that needs to be addressed.

The present invention intends to provide a fiber optic connection device to eliminate the shortcomings mentioned above.

### SUMMARY OF THE INVENTION

The present invention relates to a fiber optic connection device and comprises a first fiber optic connector which comprises a first housing and a first fiber fixing member assembled within the first housing. The first fiber fixing member has a first contact surface on one side, and the first contact surface is a first inclined surface. A second fiber optic connector comprises a second housing and a second fiber fixing member assembled within the second housing. The second fiber fixing member has a second contact surface on one side. The second contact surface is a second inclined surface. The second inclined surface is located corresponding to the first inclined surface of the first contact surface. A fiber optic adapter has two ends thereof respectively connected to the first fiber optic connector and the second fiber optic connector. The first contact surface of the first fiber fixing member is connected to the second contact surface of the second fiber fixing member.

Preferably, the first fiber optic connector has a first fiber optic cable assembly. The second fiber optic connector has a second fiber optic cable assembly. The first fiber optic cable assembly is connected to the first housing and the first fiber fixing member. The second fiber optic cable assembly is connected to the second housing and the second fiber fixing member.

Preferably, the first contact surface includes two pins extending toward the second fiber optic connector. The two pins pass through the first fiber fixing member. The second contact surface includes two alignment holes defined through the second fiber fixing member. The two alignment holes extend toward the first fiber optic connector. The alignment holes are located corresponding to the pins.

Preferably, the fiber optic adapter has a first insertion hole and a second insertion hole respectively defined in two ends thereof. The first insertion hole and the second insertion hole respectively accommodate the first fiber optic connector and the second fiber optic connector.

Preferably, the first insertion hole has two first elastic protrusions and a first alignment groove. The second insertion hole has two second elastic protrusions and a second alignment groove.

Preferably, the first housing of the first fiber optic connector includes a first inner shell which is slidably fitted with a first ring and has a first alignment portion. The first ring slides towards one end thereof such that the first elastic protrusions of the first insertion hole of the fiber optic adapter are respectively engaged with two first slots of the first inner shell. The first alignment portion is fitted into the first alignment groove of the first insertion hole. The second housing of the second fiber optic connector includes a second inner shell which is slidably fitted with a second ring and has a second alignment portion. The second ring slides towards one end thereof such that the second elastic protrusions of the second insertion hole of the fiber optic adapter are respectively engaged with two second slots of the second inner shell. The second alignment portion is fitted into the second alignment groove of the second insertion hole.

The primary object of the present invention is to provide a fiber optic connection device, primarily aimed at improving the efficiency of fiber optic transmission by providing respective first inclined surfaces and second inclined surfaces on the surfaces of the first fiber fixing member and the second fiber fixing member's first contact surface and second contact surface, respectively, which correspond to each other.

The present invention will become more obvious from the following description when taken in connection with the accompanying drawings which show, for purposes of illustration only, a preferred embodiment in accordance with the present invention.

### BRIEF DESCRIPTION OF THE DRAWINGS

FIG. 1 is an exploded view of the first fiber optic connector of the present invention;

FIG. 2 is an exploded view of the first fiber optic connector and the second housing of the present invention;

FIG. 3 is a partial enlarged view of the first contact surface of the first fiber fixing member of the present invention;

FIG. 4 is an exploded view of the second fiber optic connector and the third housing of the present invention;

FIG. 5 is a partial enlarged view of the second contact surface of the second fiber fixing member of the present invention;

FIG. 6 is an exploded view of the first fiber optic connector, the second fiber optic connector, and the fiber optic adapter of the present invention;

FIG. 7 is an exploded view of the fiber optic adapter of the present invention;

FIG. 8 is another perspective exploded view of the fiber optic adapter of the present invention;

FIG. 9 is a perspective assembly view of the first fiber optic connector, the second fiber optic connector, and the fiber optic adapter of the present invention;

FIG. 10 is a cross sectional view, taken along line X-X of FIG. 9;

FIG. 11 is a plan view to show that the first contact surface contacts the second contact surface;

FIG. 12 is a motion plan view according to FIG. 11, and

FIG. 13 is a partial plan view of the contact surface of the first contact surface and the second contact surface of the present invention.

### DETAILED DESCRIPTION OF THE PREFERRED EMBODIMENT

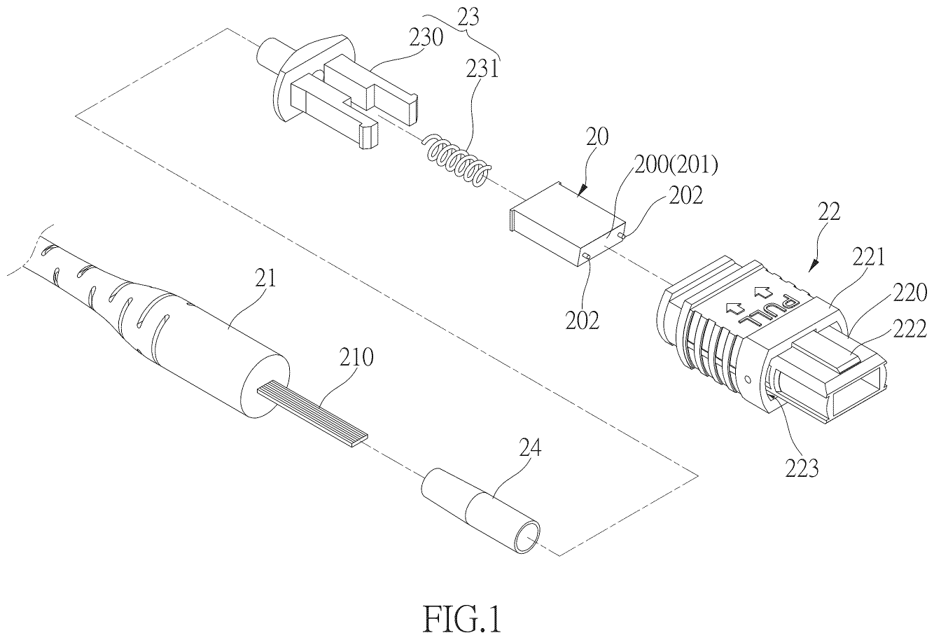

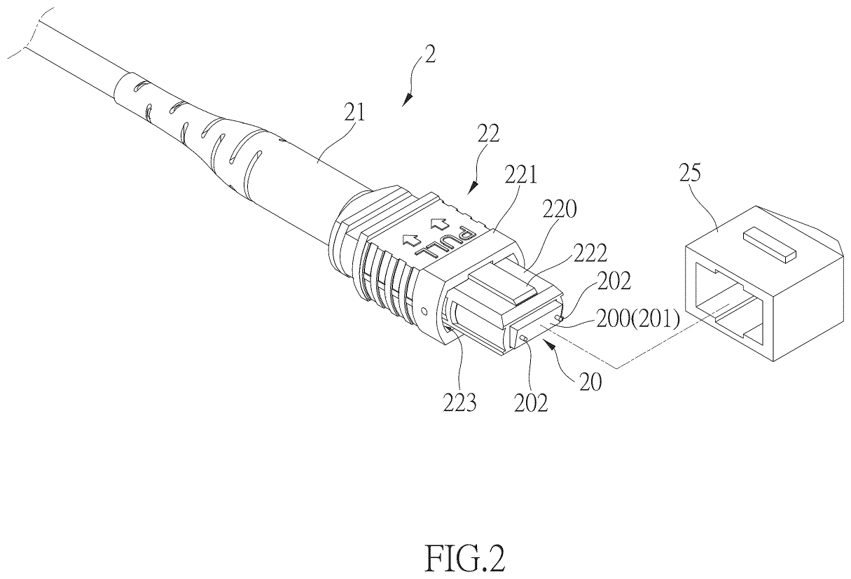

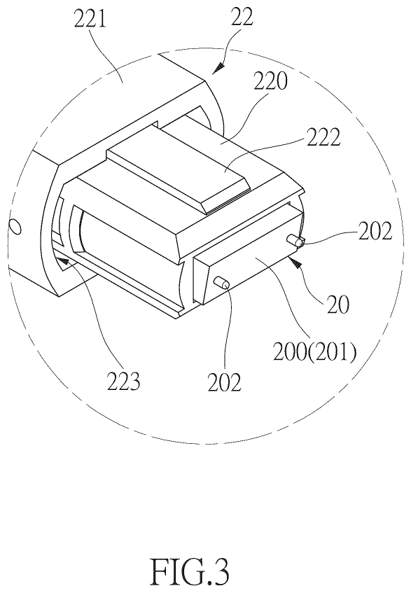

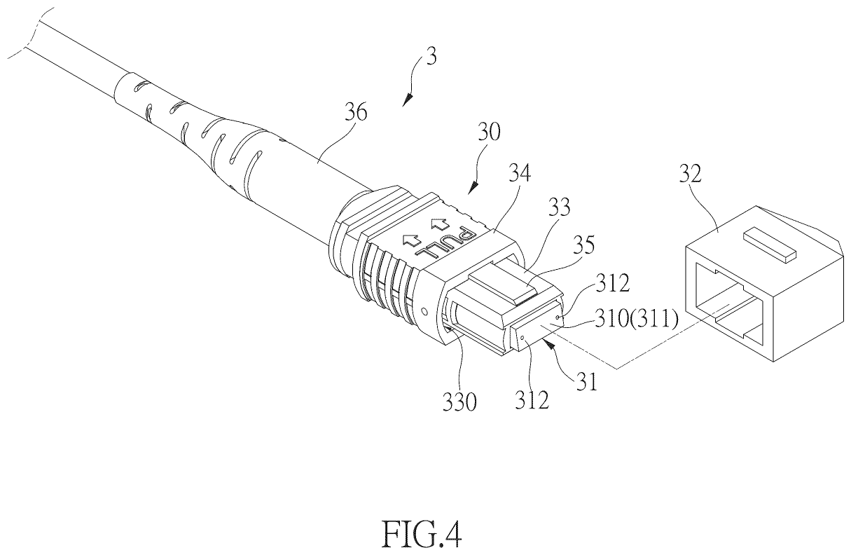

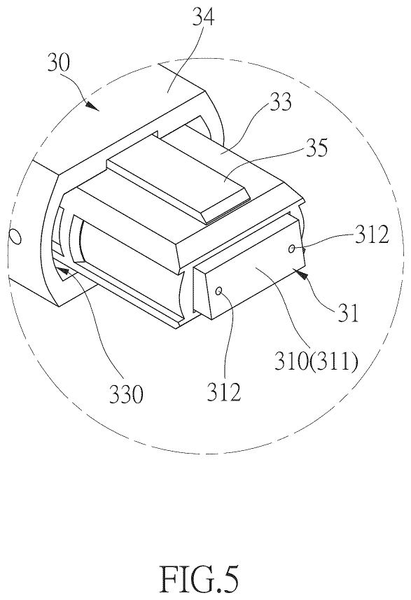

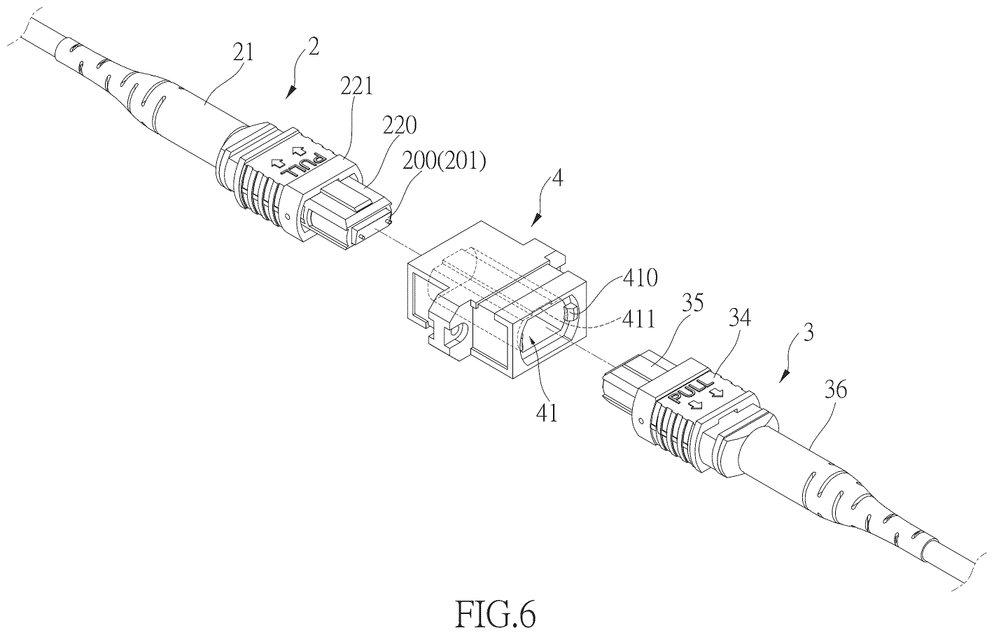

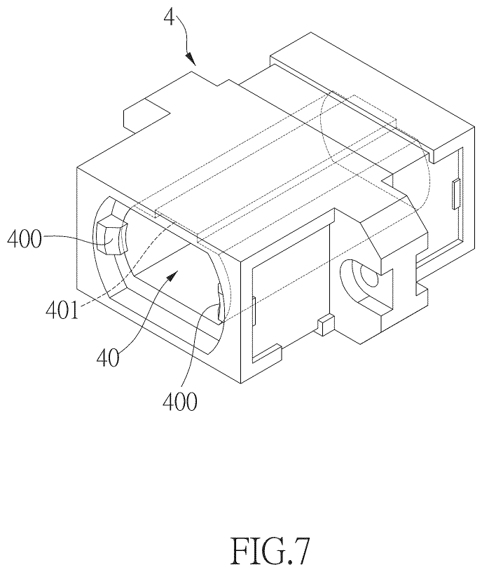

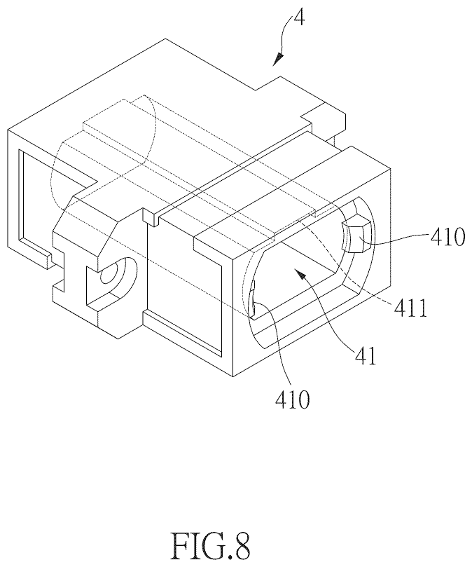

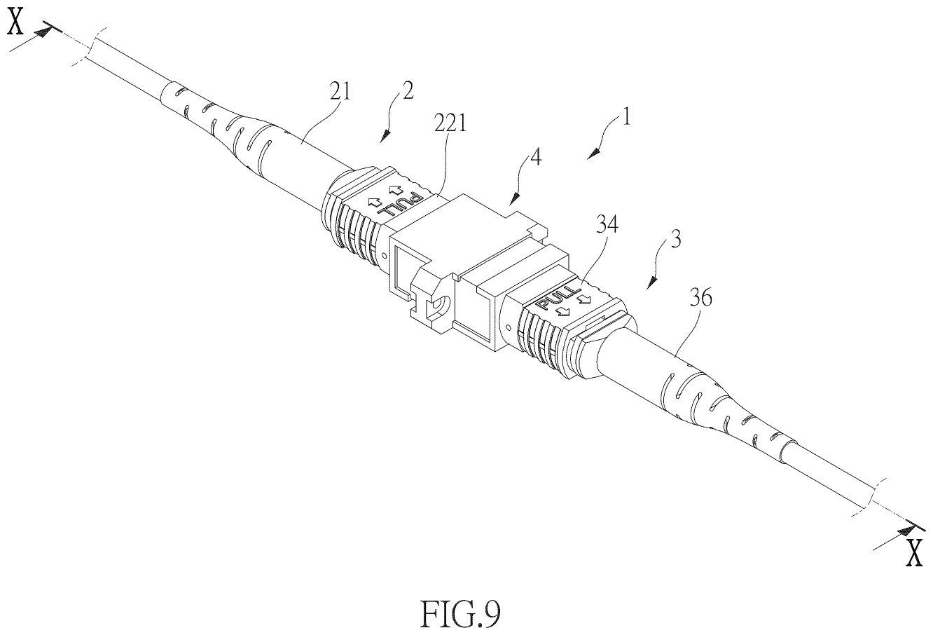

Referring to FIGS. 1 to 13, the fiber optic connection device 1 of the present invention comprises a first fiber optic connector 2 and a second fiber optic connector 3, which cooperate along the front-to-back direction to transmit fiber optic signals. The first fiber optic connector 2 and the second fiber optic connector 3 are detachably connected to a fiber optic adapter 4 in separate ways.

The first fiber optic connector 2 includes a first fiber fixing member 20, a first fiber optic cable assembly 21, a first housing 22, and an elastic component 23. One side surface of the first fiber fixing member 20 has a first contact surface 200, and the surface of the first contact surface 200 forms a first inclined surface 201. The first contact surface 200 is convexly provided with a pair of pins 202 which pass through the first fiber fixing member 20 along the mating direction with the second fiber optic connector 3. The first fiber fixing member 20, the first fiber optic cable assembly 21, and the elastic component 23 are interconnected and installed inside the first housing 22. The first contact surface 200 of the first fiber fixing member 20 and the end of the first fiber optic cable assembly 21 are exposed on both sides of the first housing 22. The elastic component 23 is placed inside the first housing 22 and includes mutually mating first mating components 230 and a first spring 231. In this embodiment, the first fiber optic connector 2 further includes a first sleeve 24 and a second sleeve 25. The first sleeve 24 fits over the exterior of the plurality of optical cores 210 of the first fiber optic cable assembly 21, while the second sleeve 25 fits over the exterior of the first housing 22 to protect the first contact surface 200 of the first fiber fixing member 20.

The second fiber optic connector 3 comprises a second housing 30, which internally accommodates a second fiber fixing member 31, a second elastic component (not shown in the figure), and a second fiber optic cable assembly 36. One side of the second fiber fixing member 31 has a second contact surface 310, which mates with the first contact surface 200 of the first fiber fixing member 20. The surface of the second contact surface 310 forms a second inclined plane 311, which corresponds to the first inclined surface 201 of the first contact surface 200.

Additionally, the second contact surface 310 is convexly provided with a pair of alignment holes 312 which pass through the second fiber fixing member 31 along the mating direction with the first fiber optic connector 2. The two alignment holes 312 are located corresponding to the pins 202. The second fiber fixing member 31, the second fiber optic cable assembly 36, and the second elastic component are interconnected and installed inside the second housing 30. The second contact surface 310 of the second fiber fixing member 31 and the end of the second fiber optic cable assembly 36 are exposed on both sides of the second housing 30. Furthermore, the composition of the remaining components of the second fiber optic connector 3 is the same as that of the first fiber optic connector 2, and the applicant does not elaborate further. In this embodiment, the second fiber optic connector 3 includes a third sleeve 32 which fits over the exterior of the second housing 30 to protect the second contact surface 310 of the second fiber fixing member 31.

Furthermore, the fiber optic adapter 4 has a first insertion hole 40 and a second insertion hole 41 defined in both ends thereof, wherein the first insertion hole 40 and the second insertion hole 41 respectively accommodate the first fiber optic connector 2 and the second fiber optic connector 3. The first insertion hole 40 has two first elastic protrusions 400 to facilitate the insertion and removal of the first fiber optic connector 2. The first insertion hole 40 further has a first alignment groove 401. The second insertion hole 41 has two second elastic protrusions 410 to facilitate the insertion and removal of the second fiber optic connector 3. The second insertion hole 41 further has a second alignment groove 411.

Furthermore, the first housing 22 of the first fiber optic connector 2 also includes a first inner shell 220, wherein the first inner shell 220 is slidably fitted with a first ring 221 and protrudes with a first alignment portion 222. The first ring 221 can slide towards one end thereof to allow the second elastic protrusions 400 of the first insertion hole 40 of the fiber optic adapter 4 to respectively engage with the first slots 223 of the first inner shell 220, and the first alignment portion 222 can fit into the first alignment groove 401 of the first insertion hole 40. Similarly, the second housing 30 of the second fiber optic connector 3 also includes a second inner shell 33, wherein the second inner shell 33 is slidably fitted with a second ring 34 and protrudes with a second alignment portion 35. The second ring 34 can slide towards one end thereof to allow the second elastic protrusions 410 of the second insertion hole 41 of the fiber optic adapter 4 to respectively engage with the second slots 330 of the second inner shell 33, and the second alignment portion 35 can fit into the second alignment grooves 411 of the second insertion hole 41.

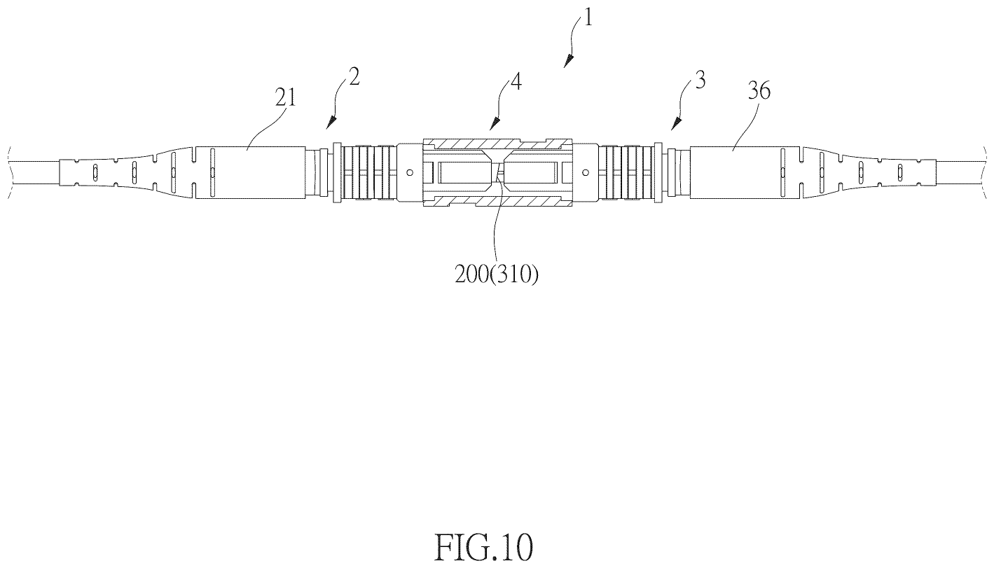

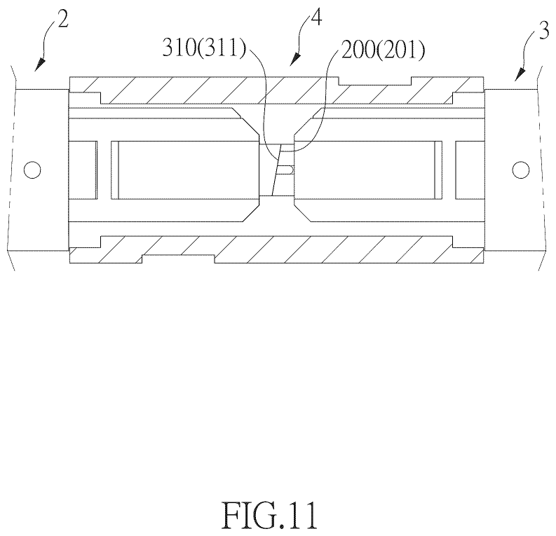

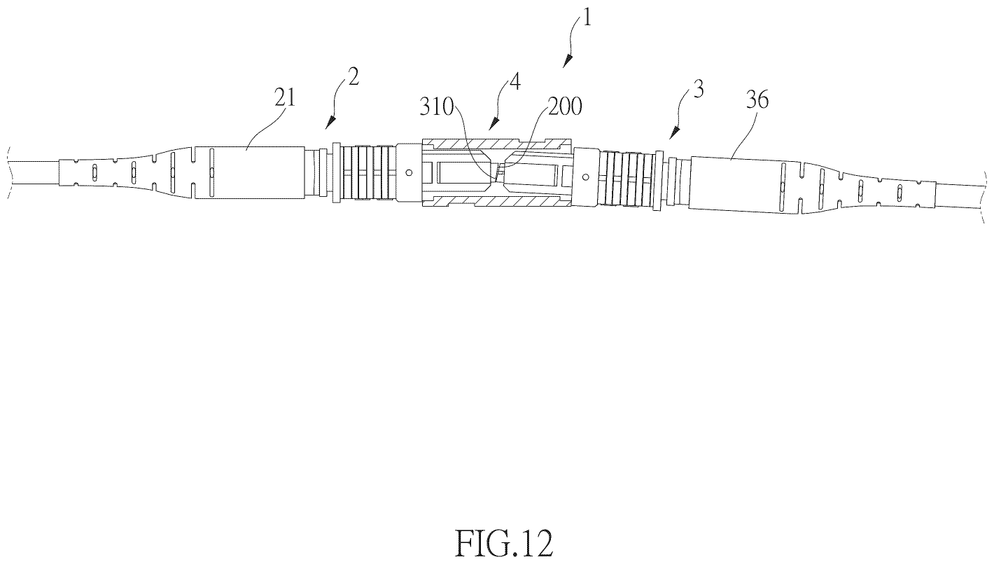

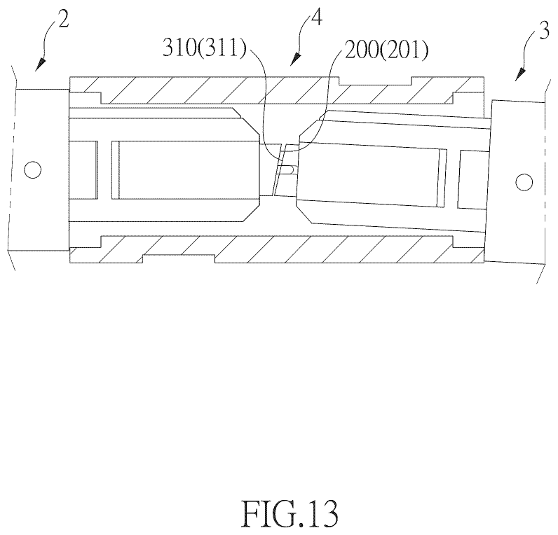

When in use, when the first fiber optic connector 2 and the second fiber optic connector 3 are fully assembled and in operational status with the fiber optic adapter 4, the first contact surface 200 of the first fiber fixing member 20 and the second contact surface 310 of the second fiber fixing member 31 are in mutual contact and in a tightly coupled state (as shown in FIGS. 10 and 11), enabling stable transmission of fiber optic signals. When the contact between the first fiber fixing member 20 and the second fiber fixing member 31 is subjected to external force or frequent insertion and removal, the first contact surface 200 and the second contact surface 310 which are respectively formed with corresponding first inclined surface 201 and second inclined surface 311, ensure that there is still partial contact area between them (as shown in FIGS. 12 and 13), avoiding a decrease in fiber optic transmission efficiency and signal transmission caused by unstable external forces during the operational status of the first fiber optic connector 2 and the second fiber optic connector 3. While we have shown and described the embodiment in accordance with the present invention, it should be clear to those skilled in the art that further embodiments may be made without departing from the scope of the present invention.

While we have shown and described the embodiment in accordance with the present invention, it should be clear to those skilled in the art that further embodiments may be made without departing from the scope of the present invention.

What is claimed is:

1. A fiber optic connection device (1) comprises:
a first fiber optic connector (2) comprising a first housing (22) and a first fiber fixing member (20) assembled within the first housing (22), the first fiber fixing member (20) having a first contact surface (200) on one side, the first contact surface (200) being a first inclined surface (201);
a second fiber optic connector (3) comprising a second housing (30) and a second fiber fixing member (31) assembled within the second housing (30), the second fiber fixing member (31) having a second contact surface (310) on one side, the second contact surface (310) being a second inclined surface (311), the second inclined surface (311) located corresponding to the first inclined surface (201) of the first contact surface (200), and
a fiber optic adapter (4) having two ends thereof respectively connected to the first fiber optic connector (2) and the second fiber optic connector (3), the first contact surface (200) of the first fiber fixing member (20) being connected to the second contact surface (310) of the second fiber fixing member (31).

2. The fiber optic connection device as claimed in claim 1, wherein the first fiber optic connector (2) has a first fiber optic cable assembly (21), the second fiber optic connector (3) has a second fiber optic cable assembly (36), the first fiber optic cable assembly (21) is connected to the first housing (22) and the first fiber fixing member (20), the second fiber optic cable assembly (36) is connected to the second housing (30) and the second fiber fixing member (31).

3. The fiber optic connection device as claimed in claim 1, wherein the first contact surface (200) includes two pins (202) extending toward the second fiber optic connector (3), the two pins (202) pass through the first fiber fixing member (20), the second contact surface (310) includes two alignment holes (312) defined through the second fiber fixing member (31), the two alignment holes (312) extend toward the first fiber optic connector (2), the alignment holes (312) are located corresponding to the pins (202).

4. The fiber optic connection device as claimed in claim 1, wherein the fiber optic adapter (4) has a first insertion hole (40) and a second insertion hole (41) respectively defined in two ends thereof, the first insertion hole (40) and the second insertion hole (41) respectively accommodate the first fiber optic connector (2) and the second fiber optic connector (3).

5. The fiber optic connection device as claimed in claim 4, wherein the first insertion hole (40) has two first elastic protrusions (400) and a first alignment groove (401), the second insertion hole (41) has two second elastic protrusions (410) and a second alignment groove (411).

6. The fiber optic connection device as claimed in claim 5, wherein the first housing (22) of the first fiber optic connector (2) includes a first inner shell (220), the first inner shell (220) is slidably fitted with a first ring (221) and has a first alignment portion (222), the first ring (221) slides towards one end thereof such that the first elastic protrusions (400) of the first insertion hole (40) of the fiber optic adapter (4) are respectively engaged with two first slots (223) of the first inner shell (220), the first alignment portion (222) is fitted into the first alignment groove (401) of the first insertion hole (40), the second housing (30) of the second fiber optic connector (3) includes a second inner shell (33), the second inner shell (33) is slidably fitted with a second ring (34) and has a second alignment portion (35), the second ring (34) slides towards one end thereof such that the second elastic protrusions (410) of the second insertion hole (41) of the fiber optic adapter (4) are respectively engaged with two second slots (330) of the second inner shell (33), the second alignment portion (35) is fitted into the second alignment groove (411) of the second insertion hole (41).
